(19) United States
(12) Patent Application Publication
(10) Pub. No.: US 2008/0013027 A1
(43) Pub. Date: Jan. 17, 2008

(54) Liquid Crystal Display Device and Electronic Device Using the Same

(76) Inventors: Tadashi Kawamura, Nara-shi (JP); Masumi Kubo, Ikoma-shi (JP); Hiroyuki Ohgami, Kawanishi-cho (JP); Hisakazu Nakamura, Yamatokoriyama-shi (JP); Akihiro Yamamoto, Yamatokoriyama-shi (JP); Takashi Ochi, Tenri-shi (JP); Yohichi Naruse, Nagoya-shi (JP)

Correspondence Address: NIXON & VANDERHYE, PC, 901 NORTH GLEBE ROAD, 11TH FLOOR, ARLINGTON, VA, 22203, US

(21) Appl. No.: 11/666,652

(22) PCT Filed: Oct. 25, 2005
(86) PCT No.: PCT/JP05/19620

§ 371 Date: May 1, 2007

(30) Foreign Application Priority Data
Nov. 5, 2004 (JP) 2004-322021

(51) Int. Cl. G02F 1/1343

(52) U.S. Cl. 349/143

(57) ABSTRACT

While securing adequate response characteristics and brightness of an orientation-divided vertical alignment type liquid crystal display device, variations in display quality that are ascribable to variations in the pixel structure are suppressed. A liquid crystal display device according to the present invention includes a plurality of pixels each having a first electrode, a second electrode opposing the first electrode, and a vertical-alignment type liquid crystal layer provided between the first electrode and the second electrode, including: a rib provided on the first electrode side of the liquid crystal layer, and a slit provided in the second electrode of the liquid crystal layer. The thickness of the liquid crystal layer is no more than 2.5 μm, and the width of the rib is no less than 5 μm and no more than 13 μm.

### TECHNICAL FIELD

The present invention relates to a liquid crystal display device and an electronic device incorporating the same, and particularly to an orientation-divided vertical alignment type liquid crystal display device having wide viewing angle characteristics and an electronic device incorporating such a liquid crystal display device.

### BACKGROUND ART

In recent years, liquid crystal display devices (hereinafter referred to as “LCDs”) have come into wide use. The mainstream so far has been TN-type LCDs, in which nematic liquid crystal having a positive dielectric anisotropy is placed in a twist alignment. TN-type LCDs have a problem in that they have a large viewing angle dependence associated with the orientations of liquid crystal molecules.

In order to improve the viewing angle dependence, orientation-divided vertical alignment type LCDs have been developed, and are being used more and more. For example, Patent Document 1 discloses an MVA-type LCD, which is a kind of orientation-divided vertical alignment type LCD. This MVA-type LCD is an LCD which performs display in a normally-black (NB) mode by using a vertical-alignment type liquid crystal layer which is provided between a pair of electrodes. Domain regulating means (e.g., slits or protrusions) are provided, so that the liquid crystal molecules in each pixel will fall (tilt) in a number of different directions under an applied voltage.

Recently, needs are rapidly increasing for displaying moving picture information on not only a liquid crystal television set but also a monitor device for a PC or a mobile terminal device (e.g., a mobile phone or PDA). In order to display moving pictures on an LCD with a high quality, it is necessary to reduce the response time (i.e., increase the response speed) of the liquid crystal layer, and it is a requirement to reach a predetermined gray scale level within one vertical scanning period (which typically is one frame).

One method of improving the response characteristics of an MVA-type LCD may be to increase the size of the domain regulating means provided within the pixel, for example. In other words, by broadening the width of the ribs or broadening the width of the slits, the orientation regulating force for the liquid crystal layer can be enhanced, whereby the response characteristics can be improved.

[Patent Document 1] Japanese Patent No. 2947350

### DISCLOSURE OF INVENTION

### Problems to be Solved by the Invention

However, broadening the rib width or slit width for obtaining an enhanced orientation regulating force will correspondingly lower the aperture ratio: {(pixel area−rib area−slit area)/pixel area}, thus lowering the transmittance. Therefore, it is difficult to realize both excellent response characteristics and sufficient brightness at the same time.

Moreover, in an actual liquid crystal display device, shape and positioning of the domain regulating means may deviate from their design values, due to the influences of variations in the production process or positioning tolerance when attaching the substrates, etc. Thus, there are variations in the structure of the pixel. Such variations in the pixel structure lead to variations in transmittance, and variations in display quality.

The present invention has been made in view of the above problems, and an objective thereof is to suppress variations in display quality that are ascribable to variations in the pixel structure, while securing adequate response characteristics and brightness of an orientation-divided vertical alignment type liquid crystal display device.

### Means for Solving the Problems

A liquid crystal display device according to the present invention comprises a plurality of pixels each having a first electrode, a second electrode opposing the first electrode, and a vertical-alignment type liquid crystal layer provided between the first electrode and the second electrode, and includes: a rib provided on the first electrode side of the liquid crystal layer, and a slit provided in the second electrode of the liquid crystal layer, wherein, thickness of the liquid crystal layer is no more than 2.5 μm; and width of the rib is no less than 5 μm and no more than 13 μm. Thus, the aforementioned objective is met.

In a preferred embodiment, height of the rib/thickness of the liquid crystal layer is no less than 0.25 and no more than 0.47.

In a preferred embodiment, width of the rib is no less than 6.8 μm and no more than 8.8 μm.

In a preferred embodiment, height of the rib/thickness of the liquid crystal layer is no less than 0.2 and no more than 0.5.

In a preferred embodiment, width of the slit is no less than 5.5 μm and no more than 11.5 μm.

In a preferred embodiment, width of the slit is no less than 9 μm and no more than 10 μm.

Alternatively, a liquid crystal display device according to the present invention comprises a plurality of pixels each having a first electrode, a second electrode opposing the first electrode, and a vertical-alignment type liquid crystal layer provided between the first electrode and the second electrode, and includes: a rib provided on the first electrode side of the liquid crystal layer, and a slit provided in the second electrode of the liquid crystal layer, wherein, thickness of the liquid crystal layer is no more than 2.5 μm; and width of the slit is no less than 5.5 μm and no more than 11.5 μm. Thus, the aforementioned objective is met.

In a preferred embodiment, height of the rib/thickness of the liquid crystal layer is no less than 0.25 and no more than 0.5.

In a preferred embodiment, width of the slit is no less than 9 μm and no more than 10 μm.

In a preferred embodiment, height of the rib/thickness of the liquid crystal layer is no less than 0.2 and no more than 0.45.

Alternatively, a liquid crystal display device according to the present invention comprises a plurality of pixels each having a first electrode, a second electrode opposing the first electrode, and a vertical-alignment type liquid crystal layer provided between the first electrode and the second electrode, and includes: a rib provided on the first electrode side of the liquid crystal layer, and a slit provided in the second electrode of the liquid crystal layer, wherein, thickness of the liquid crystal layer is no more than 2.5 μm; width of the rib is no less than 6.8 μm and no more than 8.8 μm; and width of the slit is no less than 9 μm and no more than 10 μm. Thus, the aforementioned objective is met.

In a preferred embodiment, the first electrode is a counter electrode, and the second electrode is a pixel electrode.

In a preferred embodiment, the liquid crystal display device according to the present invention includes a pair of polarizers opposing each other via the liquid crystal layer, wherein transmission axes of the pair of polarizers are substantially orthogonal to each other, one of the transmission axes being along a horizontal direction of the display surface; and the rib and the slit are disposed so that a direction in which each extends constitutes substantially 45° with the one transmission axis.

An electronic device according to the present invention comprises a liquid crystal display device having the above construction. Thus, the aforementioned objective is met.

In a preferred embodiment, the electronic device according to the present invention further comprises circuitry for receiving television broadcasts.

### Effects of the Invention

In an orientation-divided vertical alignment type liquid crystal display device according to the present invention, the thickness of a liquid crystal layer is set within a predetermined range, and also the thickness of ribs, the width of slits, and rib height/liquid crystal layer thickness are set within predetermined ranges. As a result, it is possible to perform display with a sufficient brightness and with good response characteristics, and variations in display quality that are ascribable to variations in the pixel structure are suppressed.

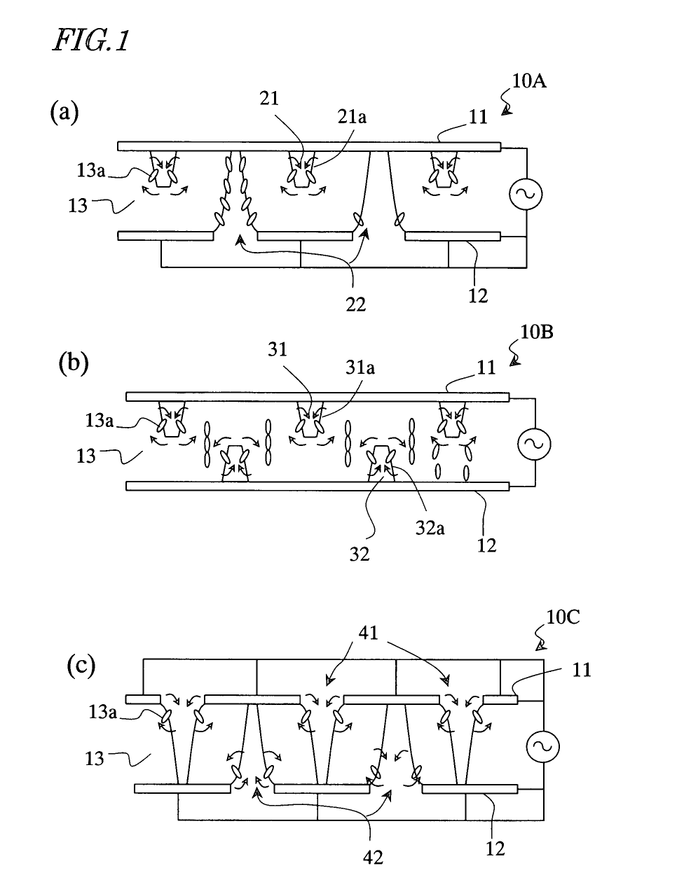

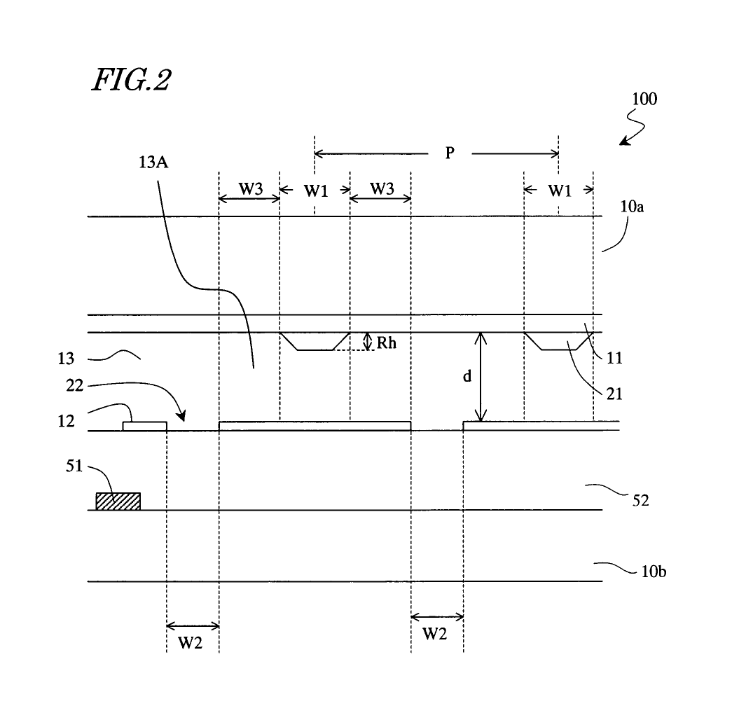

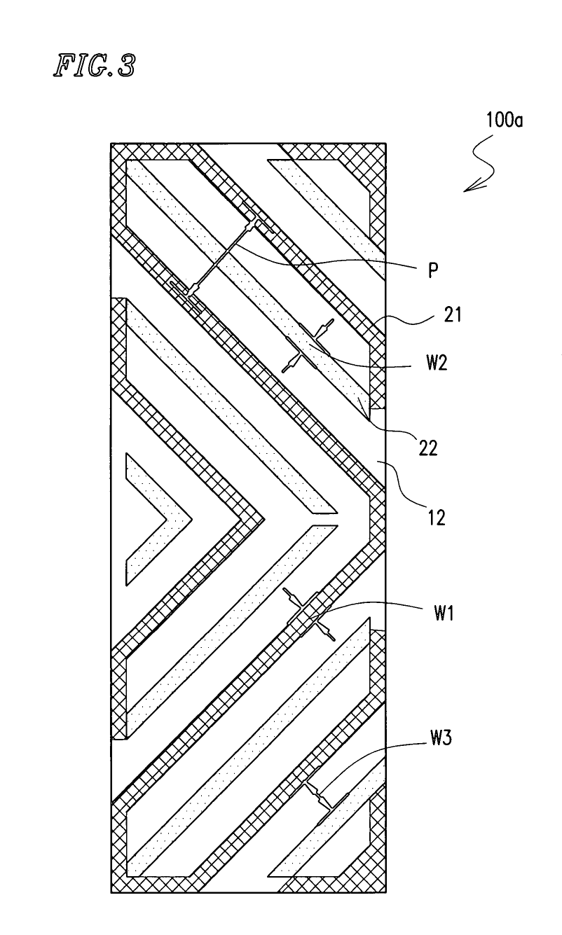

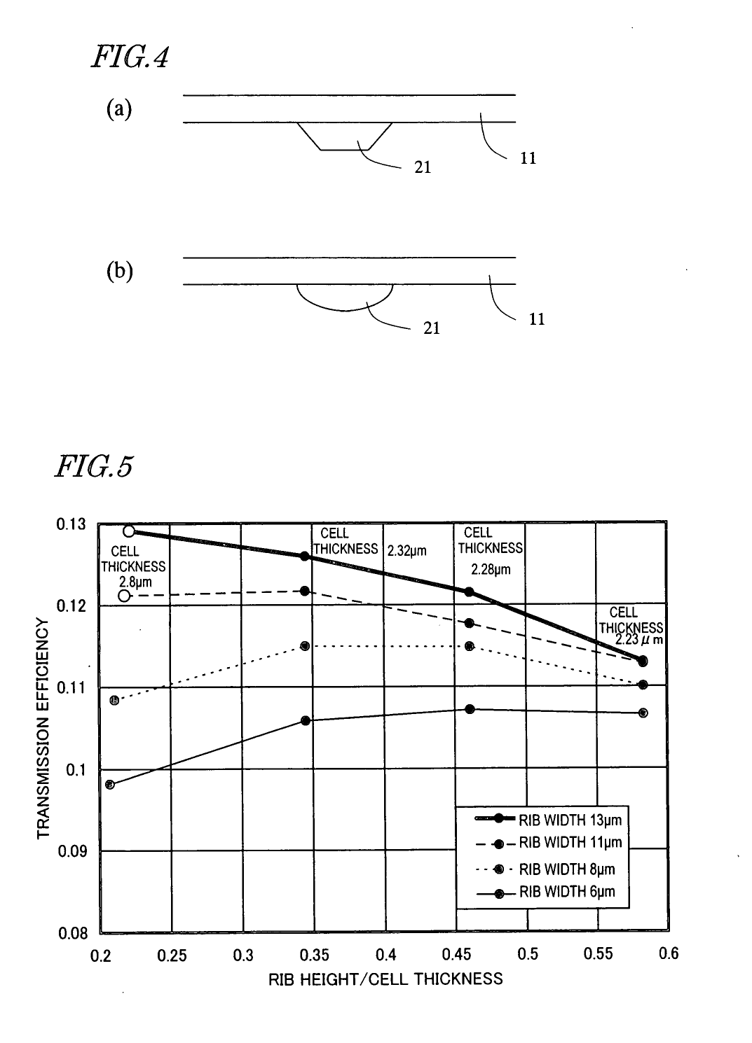

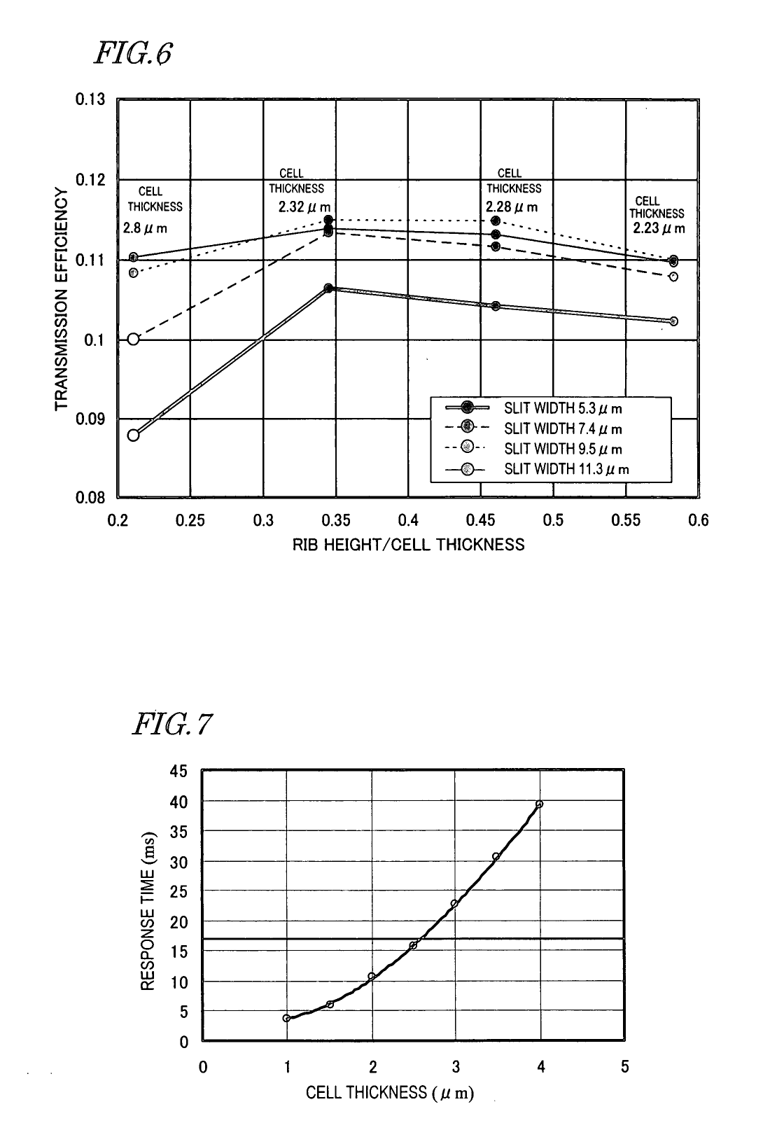

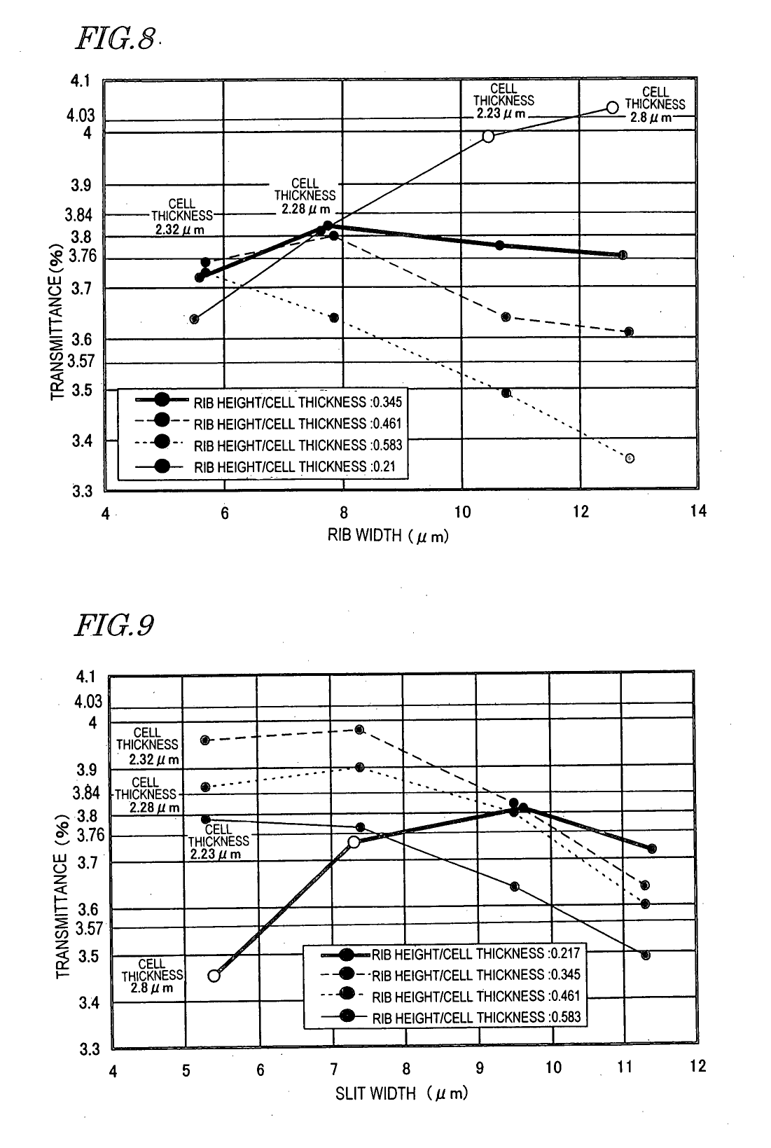

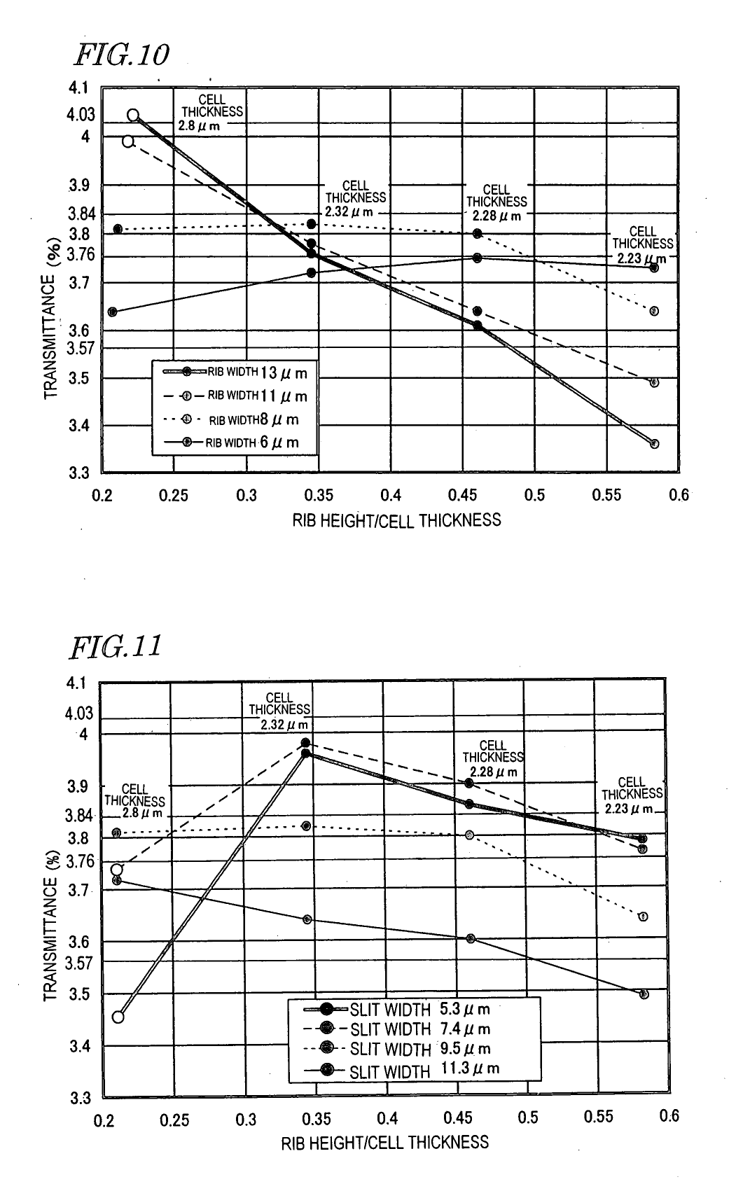

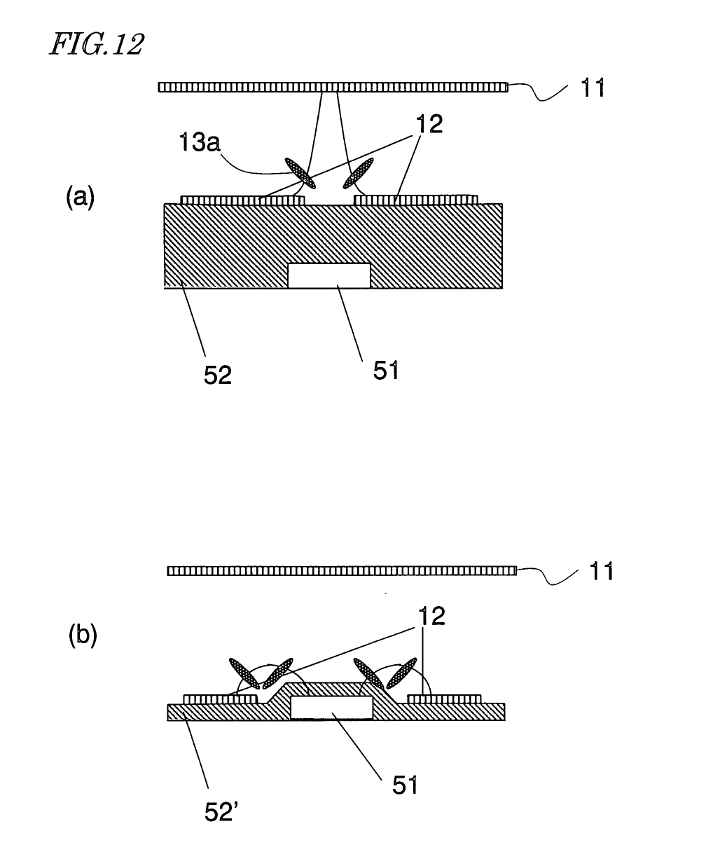

### BRIEF DESCRIPTION OF DRAWINGS

[FIG. 1] (a) is a cross-sectional view schematically showing an exemplary basic construction of an MVA-type LCD according to an embodiment of the present invention; and (b) and (c) are cross-sectional views schematically showing other examples of MVA-type LCD constructions.

[FIG. 2] A partial cross-sectional view schematically showing a cross-sectional structure of an LCD 100 according to an embodiment of the present invention.

[FIG. 3] A plan view schematically showing a pixel section 100a of the LCD 100.

[FIGS. 4] (a) and (b) are cross-sectional views schematically showing examples of a rib 21 to be used in the LCD 100.

[FIG. 5] A graph showing results of measuring transmission efficiency while varying the rib height, cell thickness, and rib width.

[FIG. 6] A graph showing results of measuring transmission efficiency while varying the rib height, cell thickness, and slit width.

[FIG. 7] A graph showing a relationship between cell thickness and response time.

[FIG. 8] A graph showing results of measuring transmittance (%) while varying the rib width with respect to a plurality of values of rib height/cell thickness.

[FIG. 9] A graph showing results of measuring transmittance (%) while varying the slit width with respect to a plurality of values of rib height/cell thickness.

[FIG. 10] A graph showing results of measuring transmittance (%) while varying the rib height/cell thickness with respect to a plurality of values of rib width.

[FIG. 11] A graph showing results of measuring transmittance (%) while varying the rib height/cell thickness with respect to a plurality of values of slit width.

[FIGS. 12] (a) and (b) are schematic diagrams for explaining the influence of an interlayer insulating film on the orientations of liquid crystal molecules.

### DESCRIPTION OF THE REFERENCE NUMERALS

11 first electrode
12 second electrode
13 liquid crystal layer
13A liquid crystal region
13a liquid crystal molecules
21 rib (orientation regulating means)
22 slit (orientation regulating means)

### BEST MODE FOR CARRYING OUT THE INVENTION

Hereinafter, an embodiment of the present invention will be described with reference to the figures. Note that the present invention is not to be limited to the following embodiment.

First, the construction of an orientation-divided vertical alignment type LCD according to the present embodiment will be described with reference to FIG. 1(a).

The LCD 10A of the present embodiment comprises a plurality of pixels, each including a first electrode 11, a second electrode 12 opposing the first electrode 11, and a vertical-alignment type liquid crystal layer 13 provided between the first electrode 11 and the second electrode 12. In the vertical-alignment type liquid crystal layer 13, liquid crystal molecules having a negative dielectric anisotropy are oriented substantially perpendicular (e.g., no less than 87° and no more than 90°) to the planes of the first electrode 11 and the second electrode 12 in the absence of an applied voltage. Typically, the vertical-alignment type liquid crystal layer 13 is obtained by providing a vertical alignment film (not shown) on a surface of each of the first electrode 11 and the second electrode 12 that faces the liquid crystal layer 13. Note that, in the case where ribs (protrusions) or the like (described later) are provided as orientation regulating means, the liquid crystal molecules will be oriented substantially perpendicular to the surfaces of the ribs or the like facing the liquid crystal layer 13.

Ribs 21 are provided on the first electrode 11 side of the liquid crystal layer 13, and slits 22 are provided on the second electrode 12 side of the liquid crystal layer 11. In a liquid crystal region between a rib 21 and a slit 22, liquid crystal molecules 13a receive orientation regulating forces from the rib 21 and the slit 22, such that the liquid crystal molecules 13a will fall (tilt) in a direction indicated by arrows in the figure when a voltage is applied between the first electrode 11 and the second electrode 12. In other words, the liquid crystal molecules fall in a uniform direction within each liquid crystal region, and therefore each liquid crystal region can be regarded as a domain.

The ribs 21 and slits 22 (which may be collectively referred to as “orientation regulating means”; the orientation regulating means would correspond to the domain regulating means which are described in the aforementioned Patent Document 1) are each provided in a stripe shape within each pixel. FIG. 1(a) is a cross-sectional view taken along a direction orthogonal to a direction in which the stripe-shaped orientation regulating means extend. On both sides of each orientation regulating means, liquid crystal regions (domains) are formed in which the liquid crystal molecules 13a fall in directions which are 180° apart.

In the LCD 10A, the ribs 21 and the slits 22 each extend in a stripe shape (strip shape). Each rib 21 causes the liquid crystal molecules 13a to be oriented substantially perpendicular to their side faces 21a, thus causing the liquid crystal molecules 13a to be oriented in directions orthogonal to the direction in which the rib 21 extends. When a potential difference is created between the first electrode 11 and the second electrode 12, each slit 22 generates an oblique electric field in the liquid crystal layer 13 near the edges of the slit 22, thus causing the liquid crystal molecules 13a to be oriented in directions orthogonal to the direction in which the slit 22 extends. The ribs 21 and the slits 22 are disposed parallel to one another, with a predetermined interval therebetween, so that a liquid crystal region (domain) is formed between every adjoining rib 21 and slit 22. That is, the liquid crystal layer 13 in the pixel region is orientation-divided.

Although the present invention adopts the construction shown in FIG. 1(a) for reasons described below, constructions shown in FIG. 1(b) and FIG. 1(c) are also known as MVA-type LCDs.

An LCD 10B shown in FIG. 1(b) differs from the LCD 10A of FIG. 1(a) in that ribs 31 and ribs 32 are comprised as first and second orientation regulating means which are provided on both sides of the liquid crystal layer 13. The ribs 31 and ribs 32 are disposed parallel to one another, with a predetermined interval therebetween, and cause the liquid crystal molecules 13a to be oriented substantially perpendicular to side faces 31a of the ribs 31 and side faces 32a of the ribs 32, whereby liquid crystal regions (domains) are formed between them.

An LCD 10C shown in FIG. 1(c) differs from the LCD 10A of FIG. 1(a) in that slits 41 and slits 42 are comprised as first and second orientation regulating means which are provided on both sides of the liquid crystal layer 13. When a potential difference is created between the first electrode 11 and the second electrode 12, the slits 41 and the slits 42 generate oblique electric fields in the liquid crystal layer 13 near the edges of the slits 41 and 42, thus causing the liquid crystal molecules 13a to be oriented in directions orthogonal to the direction in which the slits 41 and 42 extend. The slits 41 and the slits 42 are disposed parallel to one another, with a predetermined interval therebetween, whereby liquid crystal regions (domains) are formed between them.

The LCD 10A of the present embodiment employs ribs 21 and slits 22 as orientation regulating means which are provided on both sides of the liquid crystal layer. This construction suppresses an increase in the black luminance associated with the orientation regulating force of the slopes of the ribs, as compared to the construction of the LCD 10B in which ribs 31 and 32 are provided on both sides of the liquid crystal layer 13.

Moreover, the construction of the LCD 10A shown in FIG. 1(a) also provides an advantage in that the increase in production steps can be minimized. Providing slits in the pixel electrode does not require any additional steps. On the other hand, as for the counter electrode, providing ribs will induce a smaller increase in the number of steps than providing slits. Note that the first electrode 11 and the second electrode 12 only need to be electrodes which oppose each other via the liquid crystal layer 13. Typically, one of them is a counter electrode, whereas the other is a pixel electrode. Hereinafter, the embodiment of the present invention will be described with respect to an example where the first electrode 11 is a counter electrode and the second electrode 12 is a pixel electrode.

Next, with reference to FIG. 2 and FIG. 3, the basic construction of the LCD according to an embodiment of the present invention will be described more specifically. FIG. 2 is a partial cross-sectional view schematically showing a cross-sectional structure of the LCD 100 according to the present invention, and FIG. 3 is a plan view of a pixel section 100a of the LCD 100. Since the LCD 100 has a similar basic construction to that of the LCD 10A of FIG. 1(a), like constituent elements will be denoted by like reference numerals.

The LCD 100 includes a vertical-alignment type liquid crystal layer 13 between a first substrate (e.g., a glass substrate) 10a and a second substrate (e.g., a glass substrate) 10b. A counter electrode 11 is formed on a surface of the first substrate 10a facing the liquid crystal layer 13, with ribs 21 being formed further thereon. A vertical alignment film (not shown) is formed over essentially the entire surface, including the ribs 21, of the counter electrode 11 on the side of the liquid crystal layer 13. As shown in FIG. 3, each rib 21 extends in a stripe shape, and its width W1 (i.e., width along a direction orthogonal to the direction in which it extends) is constant. Moreover, adjoining ribs 21 are disposed parallel to each other, with a constant interval (pitch) P therebetween.

On the surface of the second substrate (e.g., a glass substrate) 10b facing the liquid crystal layer 13, a gate bus line (scanning line) and a source bus line (signal lines) 51 as well as a TFT (not shown) are provided, and an interlayer insulating film (transparent resin film) 52 covering them is formed. Herein, an interlayer insulating film 52 having a flat surface is provided by using a transparent resin film having a thickness of no less than 1.5 μm and no more than 3.5 μm, whereby it becomes possible to dispose the pixel electrode 12 so as to partially overlie the gate bus line and/or source bus line, thus providing an advantage of improving the aperture ratio.

The pixel electrode 12 has stripe-shaped slits 22 formed therein. A vertical alignment film (not shown) is formed over essentially the entire surface, including the slits 22, of the pixel electrode 12. As shown in FIG. 3, each slit 22 extends in a stripe shape, and its width W2 (i.e., width along a direction orthogonal to the direction in which it extends) is constant. Moreover, adjoining slits 22 are disposed parallel to each other, so as to substantially bisect the interval between adjoining ribs 21. The shape and positioning of the aforementioned ribs 21 and slits 22 may deviate from the design values under the influences of variations in the production process, positioning tolerance when attaching the substrates, etc., and the above description is not exclusive of such situations.

Between the stripe-shaped ribs 21 and slits 22 extending in parallel to one another, stripe-shaped liquid crystal regions 13A having a width W3 are defined. Each liquid crystal region 13A is regulated in terms of orientation direction, by the rib 21 and slit 22 on both sides thereof. Thus, on both sides of each of the rib 21 and slit 22, liquid crystal regions (domains) are formed in which liquid crystal molecules 13a fall in directions which are 180° apart. As shown in FIG. 3, the ribs 21 and slits 22 extend in two directions which are 90° apart. Thus, the pixel section 100a includes four liquid crystal regions 13A, the orientation directions of whose liquid crystal molecules 13a are 90° apart. Although positioning of the ribs 21 and slits 22 is not limited to this example, such a positioning will provide good viewing angle characteristics.

Note that the cross-sectional shape (i.e., cross-sectional shape along the normal direction of the substrate plane) of the ribs 21 may be trapezoidal as shown in FIG. 4(a), or semi-elliptical as shown in FIG. 4(b). The cross-sectional shape of the ribs 21 may vary depending on the type and thickness (degree of development) of the photosensitive resin used for forming the ribs 21.

Moreover, a pair of polarizers (not shown) to be placed on both sides of the first substrate 10a and second substrate 10b are disposed so that their transmission axes are substantially orthogonal to each other (cross Nicol state). By placing the polarizers so that their transmission axes constitute 450 with respect to each orientation direction of all of the four liquid crystal regions 13A whose orientation directions are 90° apart, changes in retardation caused by the liquid crystal regions 13A can be utilized most efficiently. In other words, the polarizers are preferably disposed so that their transmission axes constitute substantially 45° with respect to the directions in which the ribs 21 and slits 22 extend. Moreover, in the case of a display device for which the viewing direction is likely to be moved horizontally with respect to the display surface, e.g., a television set, it is preferable that the transmission axis of one of the pair of polarizers is in a horizontal direction with respect to the display surface, this being in order to suppress the viewing angle dependence of display quality. In the following study, the retardation of the liquid crystal layer 13 (i.e., a product Δn·d between the birefringence Δn of the liquid crystal material and the thickness d of the liquid crystal layer 13) is adjusted so as to be essentially constant regardless of the thickness d, and the ribs and slits extend in directions which are about 45° with respect to the transmission axes of the polarizers.

The MVA-type LCD 100 having the above construction is able to perform display with excellent viewing angle characteristics, but has a problem in that response characteristics and brightness are in a trade-off relationship and are difficult to be reconciled. There is also a problem in that, if variations occur in the pixel structure (i.e., sizes and relative positioning of the constituent elements within the pixel) due to variations in the production process and positioning tolerance when attaching the substrates, variations in transmittance will occur, thus resulting in variations in display quality.

In order to suppress variations in display quality while reconciling excellent response characteristics and sufficient brightness, the inventors have produced MVA-type LCDs having the basic construction shown in FIG. 2 and FIG. 3 while varying the cell parameters (e.g., cell thickness (i.e., thickness of the liquid crystal layer 13) d, rib height Rh, rib width W1, and slit width W2), and evaluated their displaying characteristics. Hereinafter, the results of evaluation and the findings obtained from the results will be described.

First, the inventors conducted a study as to reconciliation between excellent response characteristics and sufficient brightness. It has conventionally been believed that, in an orientation-divided vertical alignment type LCD employing orientation regulating means, response characteristics and brightness are in a simple trade-off relationship. The reason is that, when the rib width W1 or the slit width W2 is broadened in order to improve the response characteristics, the aperture ratio is lowered, thus resulting in lower transmittance. However, the inventors have conducted a detailed study by prototyping panels with various cell parameters, and found that in some instances brightness is not lowered even if the rib width W1 or the slit width W2 is broadened. This is ascribable to an unexpected effect that broadening the rib width W1 or the slit width W2 improves transmittance per unit area of the pixel (hereinafter referred to as “transmission efficiency”). A transmission efficiency is obtained by measuring the transmittance of a pixel, and dividing this value by the aperture ratio.

FIG. 5 shows results of measuring the transmission efficiency while varying the rib height Rh, cell thickness d, and rib width W1. FIG. 6 shows results of measuring the transmission efficiency while varying the rib height Rh, cell thickness d, and slit width W2. As can be seen from FIG. 5, the transmission efficiency is higher as the rib width W1 is broader. As can also be seen from FIG. 6, the transmission efficiency is higher as the slit width W2 is broader. Therefore, if the rib width W1 or the slit width W2 is broadened for improved response characteristics, the aperture ratio itself will decrease, but the transmission efficiency will be improved. The increase or decrease in the transmittance of the pixel as a whole is determined by a balance between a decrease in the aperture ratio and an enhancement in the transmission efficiency. Therefore, by adjusting the rib width W1 or the slit width W2 based on the aforementioned new finding on improved transmission efficiency, excellent response characteristics and sufficient brightness can be reconciled, contrary to the conventional belief that response characteristics and brightness are in a simple trade-off relationship.

However, upon further study, the inventors have found that it is preferable that the cell thickness d is equal to or less than a predetermined value in order to realize both excellent response characteristics and sufficient brightness through adjustments of the rib width W1 or the slit width W2. The reason is that increasing the cell thickness d will invite an increase in the regions which are not directly reachable by the orientation regulating forces from the orientation regulating means, and thus lower response characteristics may result which are difficult to be compensated by an adjustment of the rib width W1 or the slit width W2.

In FIG. 5 and FIG. 6, those having insufficient response characteristics (specifically, those having a response time of 16.8 ms or more) are shown plotted with white circles. As shown in FIG. 5 and FIG. 6, the response characteristics were insufficient in some LCDs having whose cell thickness d was 2.8 μm. The study of the inventors has indicated that, by prescribing the cell thickness d to be equal to or less than 2.5 μm, sufficient response characteristics (e.g., response time of less than 16.7 ms) can be realized within practical ranges of rib width W1, slit width W2, and rib height Rh. FIG. 7 shows a relationship between cell thickness d (μm) and response time (ms). As shown in FIG. 7, response characteristics with a response time of less than 16.7 ms can be realized when the cell thickness d is equal to or less than 2.5 μm.

Next, study results concerning suppression of variations in display quality will be described.

First, in order to evaluate variations in transmittance ascribable to variations in the rib height Rh or cell thickness d, transmittance was measured while varying the rib width W1, with respect to a plurality of values of rib height Rh/cell thickness d. The results are shown in FIG. 8. From FIG. 8, it can be seen that there is a strong correlation between: the variations in transmittance ascribable to variations in rib height Rh/cell thickness d; and the rib width W1.

Variations in transmittance of the LCD (variations in the display surface) include variations in transmittance of the panel itself and variations due to other factors. Variations due to other factors include variations ascribable to the luminance distribution of backlight, variations ascribable to the polarizers, and variations ascribable to the production process of the liquid crystal panel. In order to industrially stably produce LCDs without variations in display quality, the variations in transmittance of the LCD are preferably ±15% or less, and more preferably ±10% or less.

Generally speaking, there are about ±4% variations ascribable to the luminance distribution of backlight, about ±2% variations ascribable to the polarizers, and about ±2% variations ascribable to the production process of the liquid crystal panel. Now, assuming that there is a transmittance value of 100 when no considerations are given to variations, the transmittance of the brightest portion would be 108 at the maximum when taking into consideration the variations ascribable to the backlight, the polarizers, and the production process. Therefore, if the variations in transmittance of the panel itself are within 6%, the transmittance of the brightest portion can be kept within 115; and if the variations in transmittance of the panel itself is within 1%, the transmittance of the brightest portion can be kept within 110. Accordingly, the variations in transmittance of the LCD can be kept at ±15% or less by ensuring that the variations in transmittance of the panel itself are within ±6%; and the variations in transmittance of the LCD can be kept at ±10% or less by ensuring that the variations in transmittance of the panel itself are ±1%.

Therefore, assuming 3.8% as a reference transmittance, the transmittance is preferably in the range from 3.57% to 4.03%, and more preferably in the range from 3.76% to 3.84%. Note that the reference transmittance is to be determined from the standpoint of securing a certain level or more of transmittance and permitting most stable production.

As can be seen from FIG. 8, from the standpoint of avoiding variations in transmittance in spite of changes in rib height Rh/cell thickness d, it is most preferable that the rib width W1 is about 8 μm. It can also be seen from FIG. 8 that by prescribing the rib width W1 to be no less than 5 μm and no more than 13 μm, variations in transmittance can be kept within ±6% (in the range from 3.57% to 4.03%) when the rib height Rh/cell thickness d is in the range from 0.345 to 0.461. Furthermore, by prescribing the rib width W1 to be no less than 6.8 μm and no more than 8.8 μm, variations in transmittance can be kept within ±1% (in the range from 3.76% to 3.84%) when the rib height Rh/cell thickness d is in the range from 0.21 to 0.46.

Next, transmittance was measured while varying the slit width W2, with respect to a plurality of values of rib height Rh/cell thickness d. The results are shown in FIG. 9. From FIG. 9, it can be seen that there is a strong correlation between: variations in transmittance ascribable to variations in rib height Rh/cell thickness d; and the slit width W2. As can be seen from FIG. 9, from the standpoint of avoiding variations in transmittance in spite of changes in rib height Rh/cell thickness d, it is most preferable that the slit width W2 is about 9.5 μm.

It can also be seen from FIG. 9 that by prescribing the slit width W2 to be no less than 5.5 μm and no more than 11.5 μm, variations in transmittance can be kept within ±6% (in the range from 3.57% to 4.03%) when the rib height Rh/cell thickness d is in the range from 0.345 to 0.461. It can be further seen that, by prescribing the slit width W2 to be no less than 9 μm and no more than 10 μm, variations in transmittance can be kept within ±1% (in the range from 3.76% to 3.84%) when the rib height Rh/cell thickness d is in the range from 0.21 to 0.46.

Next, in order to evaluate variations in transmittance ascribable to variations in the rib width W1 or the slit width W2, transmittance was measured while varying rib height Rh/cell thickness d, with respect to a plurality of values of rib width W1 and slit width W2. The results are shown in FIG. 10 and FIG. 11. From FIG. 10, it can be seen that there is a correlation between: variations in transmittance ascribable to variations in the rib width W1; and rib height Rh/cell thickness d. It can also be seen from FIG. 11 that there is a correlation between: variations in transmittance ascribable to variations in the slit width W2; and rib height Rh/cell thickness d.

As can be seen from FIG. 10 and FIG. 11, from the standpoint of avoiding variations in transmittance in spite of changes in the rib width W1 or the slit width W2, it is most preferable that rib height Rh/cell thickness d is about 0.35.

It can also be seen from FIG. 10 that, by prescribing rib height Rh/cell thickness d to be no less than 0.25 and no more than 0.47, variations in transmittance can be kept within ±6% (in the range from 3.57% to 4.03%) when the rib width is in the range of no less than 5 μm and no more than 13 μm. It can be further seen that, by prescribing rib height Rh/cell thickness d to be no less than 0.2 and no more than 0.5, variations in transmittance can be kept within ±1% (in the range from 3.76% to 3.84%) when the rib width is in the range of no less than 6.8 μm and no more than 8.8 μm.

It can also be seen from FIG. 11 that, by prescribing rib height Rh/cell thickness d to be no less than 0.25 and no more than 0.5, variations in transmittance can be kept within ±6% (in the range from 3.57% to 4.03%) when the slit width is in the range of no less than 5.5 μm and no more than 11.5 μm. It can be further seen that, by prescribing rib height Rh/cell thickness d to be no less than 0.2 and no more than 0.45, variations in transmittance can be kept within ±1% (in the range from 3.76% to 3.84%) when the slit width is in the range of no less than 9 μm and no more than 10 μm.

As described above, by setting the thickness of the liquid crystal layer (cell thickness) d within a predetermined range, and setting the rib width W1, the slit width W2, and rib height Rh/cell thickness d within predetermined ranges, display can be performed with good response characteristics and sufficient brightness, and variations in display quality that are ascribable to variations in the pixel structure can be suppressed.

Note that, as shown in FIG. 2, the pixel electrode 12 is formed on the relatively thick interlayer insulating film 52 covering the gate bus lines and source bus lines 51, in the LCD illustrated in the present embodiment. With reference to FIGS. 12(a) and (b), the influence of the interlayer insulating film 52 on the orientations of the liquid crystal molecules 13a will be described.

As shown in FIG. 12(a), the interlayer insulating film 52 comprised in the LCD of the present embodiment is formed so as to be relatively thick (e.g., with a thickness of no less than about 1.5 μm and no more than about 3.5 μm). Therefore, even if the pixel electrodes 12 partially overlie the gate bus lines or the source bus lines 51 via the interlayer insulating film 52, the capacitances created therebetween will be too small to affect the display quality. Moreover, as schematically shown by electric lines of force in the figure, the electric fields that affect the orientations of the liquid crystal molecules 13a existing between adjoining pixel electrodes 12 are mostly oblique electric fields which are created between the counter electrode 11 and the pixel electrodes 12, and there is hardly any influence of the source bus lines 51.

On the other hand, in the case where a relatively thin interlayer insulating film (e.g., an SiO₂ film with a thickness of several hundred nm) 52′ is formed, as schematically shown in FIG. 12(b), relatively large capacitances will be created and the display quality will be lowered if the source bus lines 51 and the pixel electrodes 12 are in partially overlying relationship via the interlayer insulating film 52′, for example. In order to prevent this, it must be ensured that the pixel electrodes 12 and the source bus lines 51 are not in overlying relationship. In this case, as shown by electric lines of force in the figure, the liquid crystal molecules 13a existing between adjoining pixel electrodes 12 are greatly affected by the electric fields which are created between the pixel electrodes 12 and the source bus lines 51, so that the orientations of the liquid crystal molecules 13a at the ends of the pixel electrodes 12 will be disturbed.

As is clear from a comparison between FIG. 12(a) and FIG. 12(b), when a relatively thick interlayer insulating film 52 is provided as in the LCD of the illustrated embodiment, the liquid crystal molecules 13a are free from the influences of electric fields associated with the gate bus lines and source bus lines, thus providing an advantage in that the liquid crystal molecules 13a are well oriented in desired directions by the orientation regulating means. Moreover, since the influences of electric fields from the bus lines are reduced by providing this relatively thick interlayer insulating film 52, the orientation stabilization effect from reducing the liquid crystal layer thickness will be clearly exhibited.

As described above, the liquid crystal display device according to the present invention is able to perform display with good response characteristics and sufficient brightness, and yet variations in the display quality are suppressed. Therefore, it is suitably used in various electronic devices. For example, it can be suitably used as a liquid crystal television set by further providing circuitry for receiving television broadcasts.

### INDUSTRIAL APPLICABILITY

According to the present invention, while securing adequate response characteristics and brightness of an orientation-divided vertical alignment type liquid crystal display device, it is possible to suppress variations in display quality that are ascribable to variations in the pixel structure occurring in the production steps. An LCD according to the present invention is suitably used as a liquid crystal television set having circuitry for receiving television broadcasts, for example. It is also suitably used for various electronic devices such as personal computers and PDAs.

1. A liquid crystal display device comprising a plurality of pixels each having a first electrode, a second electrode opposing the first electrode, and a vertical-alignment type liquid crystal layer provided between the first electrode and the second electrode, including:
a rib provided on the first electrode side of the liquid crystal layer, and
a slit provided in the second electrode of the liquid crystal layer, wherein,
thickness of the liquid crystal layer is no more than 2.5 μm; and
width of the rib is no less than 5 μm and no more than 13 μm.

2. The liquid crystal display device of claim 1, wherein height of the rib/thickness of the liquid crystal layer is no less than 0.25 and no more than 0.47.

3. The liquid crystal display device of claim 1, wherein width of the rib is no less than 6.8 μm and no more than 8.8 μm.

4. The liquid crystal display device of claim 3, wherein height of the rib/thickness of the liquid crystal layer is no less than 0.2 and no more than 0.5.

5. The liquid crystal display device of claim 1, wherein width of the slit is no less than 5.5 μm and no more than 11.5 μm.

6. The liquid crystal display device of claim 5, wherein width of the slit is no less than 9 μm and no more than 10 μm.

7. A liquid crystal display device comprising a plurality of pixels each having a first electrode, a second electrode opposing the first electrode, and a vertical-alignment type liquid crystal layer provided between the first electrode and the second electrode, including:
a rib provided on the first electrode side of the liquid crystal layer, and
a slit provided in the second electrode of the liquid crystal layer, wherein,
thickness of the liquid crystal layer is no more than 2.5 μm; and
width of the slit is no less than 5.5 μm and no more than 11.5 μm.

8. The liquid crystal display device of claim 7, wherein height of the rib/thickness of the liquid crystal layer is no less than 0.25 and no more than 0.5.

9. The liquid crystal display device of claim 7, wherein width of the slit is no less than 9 μm and no more than 10 μm.

10. The liquid crystal display device of claim 9, wherein height of the rib/thickness of the liquid crystal layer is no less than 0.2 and no more than 0.45.

11. A liquid crystal display device comprising a plurality of pixels each having a first electrode, a second electrode opposing the first electrode, and a vertical-alignment type liquid crystal layer provided between the first electrode and the second electrode, including:
a rib provided on the first electrode side of the liquid crystal layer, and
a slit provided in the second electrode of the liquid crystal layer, wherein,
thickness of the liquid crystal layer is no more than 2.5 μm;
width of the rib is no less than 6.8 μm and no more than 8.8 μm; and
width of the slit is no less than 9 μm and no more than 10 μm.

12. The liquid crystal display device of claim 1, wherein the first electrode is a counter electrode, and the second electrode is a pixel electrode.

13. The liquid crystal display device of claim 1, including a pair of polarizers opposing each other via the liquid crystal layer, wherein transmission axes of the pair of polarizers are substantially orthogonal to each other, one of the transmission axes being along a horizontal direction of the display surface; and the rib and the slit are disposed so that a direction in which each extends constitutes substantially 45° with the one transmission axis.

14. An electronic device comprising the liquid crystal display device of claim 1.

15. The electronic device of claim 14, further comprising circuitry for receiving television broadcasts.
